(19) United States
(12) Patent Application Publication
(10) Pub. No.: US 2007/0139493 A1
(43) Pub. Date: Jun. 21, 2007

(54) Shipping reservoirs for inkjet printheads, and assemblies including the same

(75) Inventors: Michael Clark Campbell, Lexington, KY (US); Trevor Daniel Gray, Midway, KY (US); David Emerson Greer, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/314,579

(22) Filed: Dec. 21, 2005

(51) Int. Cl. B41J 2/175

(52) U.S. Cl. 347/86; 347/85

(57) ABSTRACT

A printhead assembly includes a printhead body including at least one printhead having a wick associated therewith, and a shipping reservoir. The shipping reservoir is operable to releasably engage the printhead body and includes at least one vented ink container for retaining ink. The shipping reservoir is engaged in the printhead body during shipment so that the wick and ink flow channels with the at least one printhead remains moist while the shipping reservoir is engaged in the printhead body.

### FIELD OF THE INVENTION

The present invention relates to an ink reservoir, and more particularly, to a removable ink reservoir for installation in a printhead during printhead testing and shipment.

### BACKGROUND OF THE INVENTION

This invention relates to an inkjet printhead with removable ink reservoirs. Inkjet printheads, as are known in the art, generally include an ink reservoir, a pressure regulator, an ink ejection chip with nozzle plate, a filter, and an ink passage from the ink reservoir to the heater chip. The ink ejection chip jets the ink out through a nozzle plate onto paper. Over time air accumulates in the ink channel between the chip and filter. This air must be managed either by purging it with a pump or storing it in such a way that it does not impede ink flow. The storage method of air management requires a large ink channel so that as air accumulates the channel is not blocked. This method is referred to as Wide Flow Feature (WFF) geometry. In WFF designs the ink channels are filled with ink at the factory and must remain that way during shipping. If air is ingested or the printhead starts to dry out its useful life is shortened. Therefore, the printhead must be shipped with some form of ink supply. However, this presents a challenge with conventional ink tanks.

### BRIEF SUMMARY OF THE INVENTION

According to one embodiment of the invention, there is disclosed a printhead assembly. The assembly includes a printhead body, where the printhead body includes at least one printhead having a wick associated therewith. The assembly also includes a shipping reservoir operable to releasably engage the printhead body, where the shipping reservoir includes at least one vented ink container for retaining ink therein. The shipping reservoir may be engaged in the printhead body during shipment so that the wick associated with the at least one printhead remains moist while the shipping reservoir is engaged in the printhead body.

According to one aspect of the invention, the shipping reservoir further includes a handle operable to permit a user to insert the printhead body into a printer. According to another aspect of the invention, the at least one vented ink container includes felt or foam for retaining the ink. According to yet another aspect of the invention, the shipping reservoir may be engaged in the printhead body during shipment, and the felt or foam retaining the ink will remain moist despite exposure to low pressures. The shipping reservoir may also be engaged in the printhead body during shipment to maintain the moisture of the wick associated with the at least one printhead while the shipping reservoir is engaged in the printhead body. Additionally, the shipping reservoir may not include a free ink chamber. According to another aspect of the invention, the ink may be used to test the printhead prior to shipping the printhead body.

According to another embodiment of the invention, there is disclosed a shipping reservoir. The shipping reservoir includes a plurality of ink containers, where the plurality of ink containers are disposed within a single shipping reservoir body, and where each of the plurality of ink containers are operable to retain ink. The shipping reservoir also includes at least one vent disposed in each of the plurality of ink containers, and at least one ink exit port associated with each of the plurality of ink containers, where the ink retained within each of the plurality of ink containers is operable to flow through the at least one exit port to a printhead corresponding to the at least one exit port. Additionally, the shipping reservoir is operable to maintain the moisture of a wick associated with the printhead while the shipping reservoir is engaged in a printhead body regardless of changes in the atmospheric pressure applied to the plurality of ink containers.

According to an aspect of the invention, the shipping reservoir further includes a handle operable to permit a user to insert the printhead body into a printer. According to another aspect of the invention, the at least one ink container includes felt or foam for retaining the ink. According to yet another aspect of the invention, the felt or foam for retaining the ink remains moist during regardless of the orientation of the plurality of ink containers. According to another aspect of the invention, the shipping reservoir does not include a free ink chamber. Furthermore, the ink may be used to test the printhead prior to shipping the printhead body.

According to yet another embodiment of the present invention, a method of maintaining wick moisture in a printhead is disclosed. The method includes providing a shipping reservoir including at least one vented ink container having ink stored therein, inserting the shipping reservoir into a printhead body to generate a printhead assembly, exposing at least one printhead wick within the printhead body to ink stored within the at least one vented ink container, and shipping the printhead assembly.

According to one aspect of the invention, the method also includes testing the printhead assembly prior to shipping the printhead assembly. According to another aspect of the invention, shipping the printhead assembly may include shipping the printhead assembly in an area of low atmospheric pressure. According to yet another aspect of the invention, the method may include instructing a customer to replace the printhead assembly with at least one standard ink tank. The method may also include printing using the printhead assembly, and/or drop counting to determine the volume of ink printed using the printhead assembly.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows a cross sectional view of an ink tank.

FIG. 2 is a perspective view of a shipping reservoir and printhead, according to an illustrative embodiment of the present invention.

FIG. 3 is an exploded view of the shipping reservoir shown in FIG. 2, according to an illustrative embodiment of the present invention.

### DETAILED DESCRIPTION OF THE INVENTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

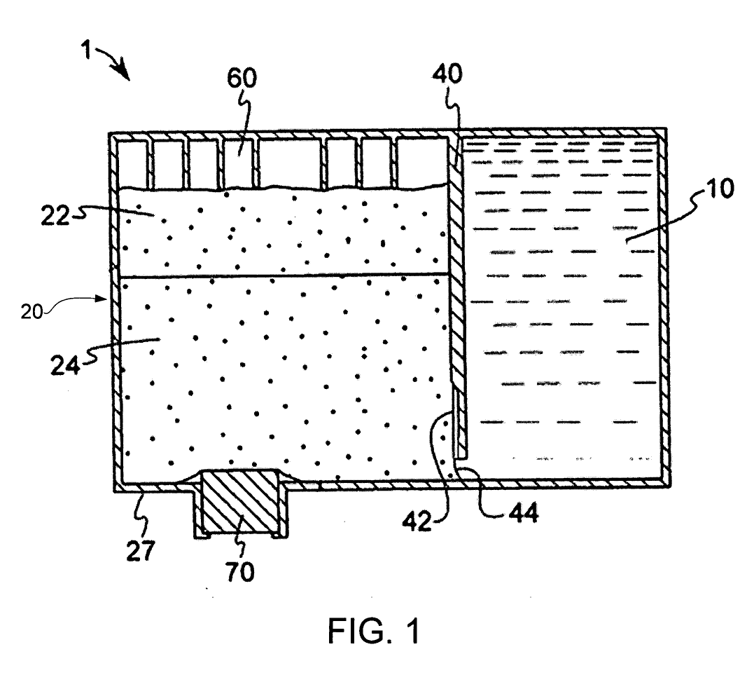

FIG. 1 shows an ink-tank 1, which includes a negative pressure generating chamber 20 and a free ink chamber 10 separated by a partitioning wall 40. The negative pressure generating chamber 20 is capable of holding felt, foam or some other negative pressure producing material that holds a liquid such as ink. The partitioning wall 40 communicates between the two chambers and controls air flow from the top of the tank 1 into the free ink chamber 10, and the air flow facilitates the release of ink from the free ink chamber 10. More specifically, the partition wall 40 is configured to allow the flow of ink 10 from the free ink chamber to the negative pressure generating chamber 20. As shown in FIG. 1, the partition wall 40 may include a recessed groove 42 etched into at least a portion of the partition wall 40, and an opening 44 below the recessed groove 42 configured to allow a flow of ink out of the free ink chamber 10 and a flow of air into the free ink chamber 10. The ink tank 1 may also include an air vent 60, which are commonly of a serpentine configuration, positioned above the negative pressure generating chamber 20.

As illustrated, the negative pressure generating chamber 20 may have multiple sections. In the embodiment shown in FIG. 1, the negative pressure generating chamber 20 has a top ink draining section 22, which includes porous material, such as felt or foam, and is configured to dispense ink. The negative pressure generating chamber 20 also includes a bottom ink drain section 24 disposed between a floor member 27 and the top ink draining section 22. Like the top ink draining section 22, the bottom ink draining section 24 also has porous material, such as felt or foam, and is configured to dispense ink. Typically, the bottom ink draining section 24 dispenses ink after the ink from the top ink draining section 22 has been drained. Additionally, the bottom ink draining section 24 may include a greater density material, such as felt, foam or an alternative material, than the porous material of the top ink draining section 22. The porous material of the bottom ink draining section 24 may be more compressed because the bottom ink draining section 24 is generally maintained under higher pressure than the top ink draining section 22.

The negative pressure generating chamber 20 releases the ink through the pores of its porous material. The ink is released via the application of pressure and/or heat to the negative pressure generating chamber 20. The ink may be first drained from the top ink draining section 22, where the draining results in a buildup of capillary pressure in the negative pressure generating chamber 20. After the ink is drained from the top ink draining section 22, the bottom ink draining section 24 begins to dispense ink due to the application of capillary pressure. The bottom ink draining section 24 releases an amount of ink sufficient to generate an air flow path in the above-described spacing between the top of the recessed groove 42 and the compressed porous material. The free ink chamber 10 will dispense ink to the negative pressure generating chamber 20 upon receiving air via the air flowpath. In essence, the free ink chamber 10 dispenses the ink and air fills the void in the chamber 10. The ink is supplied to the wick 70, which is inserted into the bottom ink draining section 24.

One characteristic of the illustrated ink tank 1 is that it functions best in a horizontal orientation. If the tank is vented and turned up 90 degrees an air path can be established between the felt and free ink chamber and ink will over saturate the felt and drool out. This will not occur if the tank is completely sealed. Therefore, the tank must be sealed during shipping. If the tank is installed onto a printhead then the printhead also must be sealed. This requires that all the seals in the printhead be completely sealed such as the tank to printhead seal, the wick retainer to filter cap seal, the nozzles, and the like. However, such seals are difficult to maintain, particularly when exposed to negative pressures, which are often encountered during transit of printheads, e.g., as experienced during cargo air travel.

In addition, the negative pressure producing materials (e.g., felts and foams) that are used in ink tanks often need to be primed before they can be used. That is, a specified amount (approximately 0.6 grams for color ink and 1.5 grams for mono ink) of ink has to be removed before the tank is used to print. In some cases, this priming of the ink tank sets an initial operating back pressure of about 5 cm of water column (cmwc). Failure to achieve this starting operating pressure of 5 cmwc, can result in drooling, which can cause unrecoverable cross contamination of the ink in the printhead.

In accordance with an embodiment of the present invention, and using the shipping reservoir described below, the required backpressure can be established by latching the shipping reservoir to a dry printhead, and filling the shipping reservoir and the printhead with ink. At or near the end of the filling process, air pressure can be applied through the shipping reservoir vent to push the ink through the shipping reservoir and out the printhead nozzles.

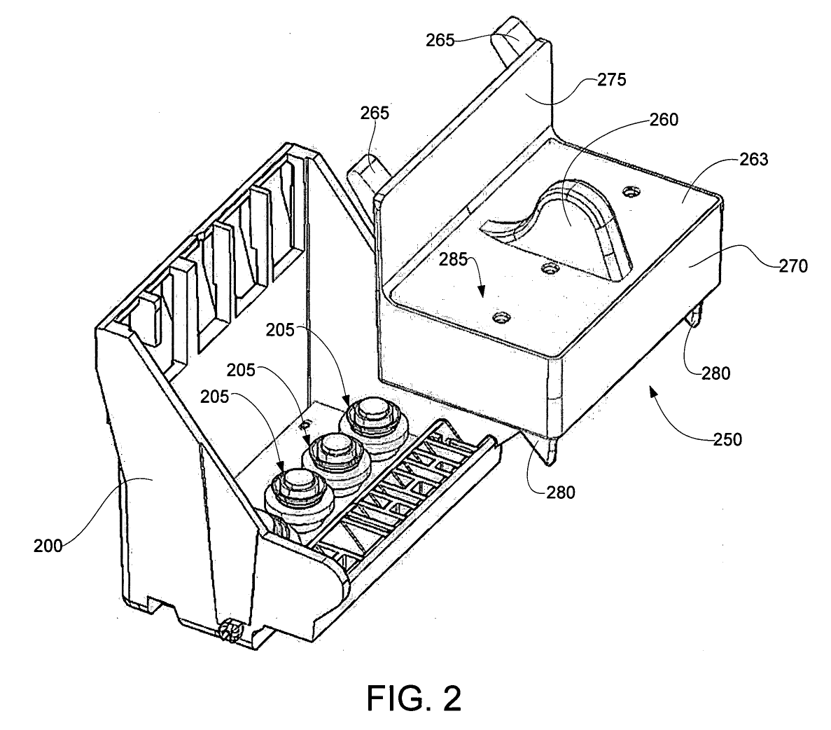

FIG. 2 shows a perspective view of a shipping reservoir 250 and a printhead body 200 into which the shipping reservoir 250 may be removably inserted, according to an illustrative embodiment of the present invention. The shipping reservoir 250 is inserted into the printhead body 200 to engage the one or more fluidic interfaces 205 that connect the printhead assembly to the ink tanks. Each fluidic interface 205 includes a wick associated therewith, which is operable to receive ink stored within the shipping reservoir, as described in greater detail below. According to one aspect of the invention, the shipping reservoir 250 may be used in conjunction with a printhead assembly that has large chambers underneath the wicks. Generally, the shipping reservoir 250 is inserted into the printhead body 200 immediately after manufacture of the printhead, and remains inserted during shipping and storage to protect the printheads 205 from ingesting too much air and drying out. The shipping reservoir 250 may be removed by a user in order to insert standard ink containers within the printhead body 200 for normal operation of a printer.

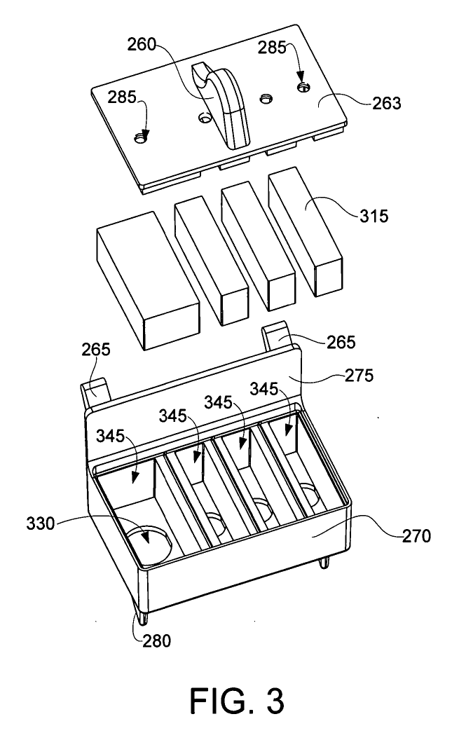

As illustrated in FIG. 2, the shipping reservoir 250 includes a shipping reservoir body 270, a lid 263, a backplane 275, a handle 260, tabs 265, and fins 280. Additionally, as illustrated in FIG. 3, the shipping reservoir body 270 includes at least one ink container 345 within which felt or foam 315 may be inserted. Each ink container 345 is operable to retain ink. According to one aspect of the invention, each ink container 345 may hold ink of a different color. For instance, in the embodiment illustrated in FIG. 3, four ink containers 345 are present and are configured to hold different ink colors, such as black, cyan, yellow, and magenta ink. It will be appreciated that the number of ink containers included within the shipping reservoir body 270 may vary and depend on the number of ink colors required for use in the printhead assembly. For instance, in alternative embodiments one, six or eight ink containers may be associated with a corresponding number of printheads that are operable to eject a specific ink color. Therefore, it will be appreciated that although the embodiment illustrated in FIGS. 2 and 3 show four fluidic connectors 205, and four ink containers 345, a shipping reservoir according to the present invention may be implemented using any number of ink containers.

Unlike prior art ink containers that are sealed, the ink containers 345 of the shipping reservoir 250 are vented and include felt or foam 315, which is similar to disposable printheads. To effect venting of the ink containers 345, each of the ink containers 345 can include at least one vent hole 285. According to one aspect of the invention, serpentine vents, vent slots, or the like, may be used as an alternative or in addition to the vent holes 285. Because the shipping reservoir 250 does not need to be sealed during shipping, this relieves the seal requirements that may be otherwise required in conventional ink tanks, as described above. The ink retained within each ink containers 345, which includes ink retained by felt or foam 315 within each containers 345, exits through an ink exit port 330. In exiting through the ink exit port is received by the wick of the corresponding printhead 205 associated with the ink container and ink exit port 330.

As shown in FIGS. 2 and 3, the shipping reservoir 250 includes a backplane 275 that permits the shipping reservoir 270 to engage the interior housing of the printhead body 200. The shipping reservoir 250 includes one or more tabs 265 affixed to the backplane 275, where the one or more tabs 265 each engage a corresponding slot within the interior of the printhead body 200 to ensure proper placement of the shipping reservoir 250. The backplane 275 permits the one or more tabs 265 to engage the slots in the printhead body 200 despite the fact that the ink containers 345 within the shipping reservoir 250 may be smaller than standard ink tanks that will be inserted into the printhead body 200 during normal operation. Thus, whereas the lid of a standard ink tank may be contiguous to the one or more tabs 265, the relatively short height of the shipping reservoir body 270 necessitates the backplane extension above the height of the shipping reservoir lid 263 in order for the tabs 265 to engage the printhead body 200. Therefore, the backplane 275 ensures that the shipping reservoir fits into printhead bodies 200 designed to receive standard ink tanks. As also shown in FIGS. 2 and 3, the shipping reservoir 250 may include one or more fins 280 that support the shipping reservoir 250 when inserted into the printhead body 200.

It will be appreciated that if standard ink tanks were shipped in the printhead body 200 and were removed to install the printhead body 200 into a printer, the wicks making the fluid connection with the standard ink tanks would be exposed. As a result, a consumer would have to be very careful installing the printhead body 200 to avoid getting ink on their fingers. In contrast, with the shipping reservoir 250 installed in the printhead body 200, the wicks remain covered. Because the printhead body 200 having the shipping reservoir 250 inserted therein may be included as a printer component to be installed by a user during setup of a printer, the shipping reservoir 250 may include a handle 260 for use in installing the printhead body 200 into the printer without being exposed to ink. As illustrated in FIGS. 2 and 3, the handle 260 may protrude from or otherwise attach to the lid 263 of the shipping reservoir 250. Additionally, although illustrated as a solid nodule in the lid 263, it will be appreciated that the handle 260 may take any suitable form to facilitate the handling of the assembly (i.e., the printhead body 200 with the shipping reservoir 250 inserted therein), such as one or more loops, tabs, handles, or the like.

According to one aspect of the invention, each ink container 345 within the shipping reservoir body 270 may contain just enough ink for testing the printhead assembly at the end of an assembly line and to prevent the fluidic connectors 205 from drying out during shelf life. Therefore, the shipping reservoir 250 may be installed as soon as the printhead assembly is primed with ink. The insertion of the shipping reservoir 270 into the printhead body 200 immediately after manufacture of the components also permits the execution of print tests to verify the printheads are working properly before the printhead body 200 is packaged and shipped. It will be appreciated that if standard ink tanks were used then each of the ink tanks would have to be installed before a verification test could be performed. Therefore, it will be appreciated that the shipping reservoir 250 should contain enough ink to facilitate manufacturer testing and to keep the printhead wicks wet during shelf life.

It will also be appreciated by those of ordinary skill in the art that the shipping reservoir 250 could also be sized large enough that it also acts as a starter cartridge. As is known in the art, a starter cartridge has less ink in it and costs less than standard ink tanks, which reduces the initial purchase price of the printer. However, unlike standard tanks, the shipping reservoir 250 does not have a free ink chamber for use in detecting ink presence. Therefore other methods to detect the tank and track the ink level may be employed. Several methods could be used to for ink tank detection. For instance, a smart chip, an RFID tag, or a reflective tab, could be added to the shipping reservoir 250 to indicate to the printer that it is a starter cartridge and thus allow printing. The printer may then utilize drop counting, as is known in the art, to determine ink level. Once the reservoir is considered close to empty the printer may record the drop count with reservoir identification and stop printing to protect the printhead from damage. A reflective tab could also be added to the shipping reservoir 250 so that the shipping reservoir 250 is identified as such, and drop counting is initiated.

After installation into a printer and when in use, the printhead body 200 shown in the illustrative embodiment of FIG. 2 will receive four ink tanks, where each ink tank is disposed directly above, and is associated, with a respective fluidic interface 205. Because the shipping reservoir 250 is much smaller than the standard tanks typically inserted into the printhead body 200, the package for the printhead body 200 may be smaller, which may necessitate less shelf space at the retailer. Additionally, the assembly of the shipping reservoir 250 and printhead body 200 (i.e., after insertion of the shipping reservoir 250 into the printhead body 200) is much cheaper than the alternative assembly created by the insertion of multiple full-size ink containers into the printhead body 200.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A shipping reservoir adapted to engage a printhead assembly, said printhead assembly having at least one fluidic interface to an ink ejection chip, each of said at least one fluidic interfaces including a wick, said shipping reservoir comprising:
a housing adapted to releasably engage said printhead assembly;
one or more ink containers disposed in said housing, each of said ink containers including an ink exit port adapted to received said wick; and
at least one negative pressure producing member disposed in each of said one or more ink containers, said negative pressure producing material adapted to receive and hold ink, said negative pressure producing material being in fluid communication with said wick to keep said wick moistened with said ink while said printhead assembly is in transit.

2. The shipping reservoir of claim 1, further comprising a lid attached to said housing.

3. The shipping reservoir of claim 2, further comprising an air vent disposed in said lid.

4. The shipping reservoir of claim 1, wherein each of said ink containers has an associated air vent.

5. The shipping reservoir of claim 2, wherein each of said ink containers has an associated air vent that is disposed in said lid and is serpentine in shape.

6. The shipping reservoir of claim 2, further comprising a handle disposed on said lid.

7. The shipping reservoir of claim 1, wherein said housing stays engaged to said printhead assembly and said negative pressure producing member stays in fluid contact with said wick during exposure to changes in pressure associated with said transit.

8. The shipping reservoir of claim 1, wherein said housing stays engaged to said printhead assembly and said negative pressure producing member stays in fluid contact with said wick during transit regardless of the orientation of said one or more ink containers.

9. The shipping reservoir of claim 1, further comprising a backplane disposed on said housing that engages said housing to said printhead assembly.

10. The shipping reservoir of claim 1, wherein said one or more ink containers holds sufficient ink to allow said printhead assembly to be tested as part of a manufacturing or assembly process.

11. A shipping reservoir adapted to engage a printhead assembly, said printhead assembly having a wick, said shipping reservoir comprising:
a housing;
a plurality of ink containers disposed in said housing, said ink containers including a negative pressure producing material adapted to retain ink;
a vent adapted to allow air into each of said plurality of ink containers; and
an exit port disposed in each of said plurality of ink containers,
wherein said negative pressure producing material is in fluid communication with said wick to allow said retained ink to move through said exit port to said printhead assembly;
wherein further said negative pressure producing material maintains said fluid communication with said wick while said printhead assembly is in transit and subject to changes in atmospheric pressure.

12. The shipping reservoir of claim 11, further comprising a handle disposed on said housing and adapted to permit a user to insert said printhead assembly into a printer.

13. The shipping reservoir of claim 11, wherein said negative pressure producing material comprises felt or foam.

14. The shipping reservoir of claim 11, wherein said negative pressure producing material is adapted to maintain fluid communication with said wick regardless of an orientation of said printhead assembly.

15. A method of testing and shipping a printhead assembly, said printhead assembly having a fluidic interface, including a wick, to an ink ejector chip, comprising:
attaching a shipping reservoir to said printhead assembly, said shipping reservoir including a vented ink container, said ink container including a negative pressure producing material that holds ink, said negative pressure producing member in fluid communication with said wick;
testing said printhead assembly by ejecting ink through said ink ejector chip, said ejected ink traveling from said negative pressure producing member through said fluidic interface, via said wick, to said ink ejector chip; and
shipping said printhead assembly with said attached shipping reservoir.
